(19) United States
(12) Patent Application Publication
(10) Pub. No.: US 2024/0078008 A1
(43) Pub. Date: Mar. 7, 2024

(54) FORCE-BASED FUNCTIONALITY FOR A GRAPHICAL USER INTERFACE INCLUDING A KEYBOARD

(71) Applicant: QUALCOMM Incorporated, San Diego, CA (US)

(72) Inventors: Raj KUMAR, San Diego, CA (US); Deepak Rajendra KARNIK, San Diego, CA (US); Seong Jun MA, San Diego, CA (US); Jeffrey Osbeli FRANCO, Los Angeles, CA (US)

(21) Appl. No.: 17/929,629

(22) Filed: Sep. 2, 2022

(51) Int. Cl. G06F 3/04886; G06F 3/0485

(52) U.S. Cl. CPC G06F 3/04886; G06F 3/0485; G06F 3/043; G06F 2203/04105

(57) ABSTRACT

Methods, devices and systems for providing a graphical user interface (GUI) including a representation of a keyboard are disclosed. Some examples may involve controlling a display system to present the GUI, including the representation of the keyboard, in at least a portion of an active force sensor area. Some examples may involve receiving, from a touch sensor system, an indication of a touch in a keyboard location of the GUI and receiving, from a force sensor system, an indication of an applied force. Some examples may involve determining whether the applied force is at or above a first force threshold and controlling keyboard functionality corresponding with the GUI according to whether the applied force is at or above the first force threshold.

### TECHNICAL FIELD

This disclosure relates generally to methods, systems and devices for presenting graphical user interfaces (GUIs), particularly GUIs that provide keyboard functionality.

### DESCRIPTION OF THE RELATED TECHNOLOGY

Many existing devices are configured to provide GUIs that include a keyboard. Such GUIs can be important features for providing input to devices, such as mobile telephones. Although some existing keyboard GUIs provide satisfactory performance, improved methods and devices would be desirable.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. In some implementations, the apparatus may include a display system, a touch sensor system, a force sensor system and a control system configured for communication with the display system, the touch sensor system and the force sensor system. The display system may include one or more displays. In some examples, the touch sensor system may include a touch screen proximate a first side of a display of the display system. In some examples, the force sensor system may include an active force sensor area proximate a second side of the display.

The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

According to some examples, the control system may be configured to control the display system to present a graphical user interface (GUI). The GUI may include a representation of a keyboard in at least a portion of the active force sensor area. In some examples, the control system may be configured to receive, from the touch sensor system, an indication of a touch in a keyboard location of the GUI and to receive, from the force sensor system, an indication of an applied force. According to some examples, the control system may be configured to determine whether the applied force is at or above a first force threshold. In some examples, the control system may be configured to control GUI keyboard functionality according to whether the applied force is at or above the first force threshold. In some examples, the indication of the applied force may be received at the keyboard location.

In some examples, the GUI may include a suggested word area in which suggested words are presented. According to some such examples, controlling the keyboard functionality may involve selecting a suggested word responsive to determining that an applied force at a keyboard location outside of the suggested word area is at or above the first force threshold. In some examples, the suggested word may be one of a plurality of suggested words. According to some such examples, controlling the keyboard functionality may involve scrolling between suggested words of the plurality of suggested words responsive to a detected digit rotation or a detected digit swipe in one or more keyboard locations outside of the suggested word area.

According to some examples, the GUI may include a symbol presentation area in which symbols corresponding to selected key images of the keyboard are presented. In some such examples, each selected key image may correspond with a keyboard location. According to some examples, the symbols may include letters. In some such examples, the control system may be further configured to determine whether a letter presented in the symbol presentation area is the first letter of a word. According to some examples, controlling the keyboard functionality may involve changing the case of the letter responsive to determining that the letter is the first letter of the word and that the applied force is at or above the first force threshold. In some such examples, the keyboard may not include a key image specifically for changing the case of a letter in the symbol presentation area. According to some examples, controlling the keyboard functionality may involve adding one or more spaces after the letter responsive to determining that the letter is not the first letter of a word and that the applied force is at or above the first force threshold.

In some examples, controlling the keyboard functionality may involve changing symbols corresponding to one or more key images of the keyboard. In some such examples, changing the symbols corresponding to the one or more key images of the keyboard may involve substituting one or more alphabetical key images for one or more non-alphabetical key images, or vice versa. In some examples, changing the symbols corresponding to the one or more key images of the keyboard may involve substituting first symbols corresponding to a first language for second symbols corresponding to a second language. In some examples, the keyboard may not include a key image specifically for changing symbols corresponding to one or more key images of the keyboard.

According to some examples, the control system may be configured to determine whether the applied force is at or above a second force threshold. In some such examples, the control system may be configured to control keyboard functionality according to whether the applied force is at or above the second force threshold.

In some examples, the control system may be configured to determine whether each applied force of a plurality of applied forces is at or above the first force threshold. In some such examples, the control system may be configured to control keyboard functionality according to whether each applied force of the plurality of applied forces is at or above the first force threshold. According to some examples, the plurality of applied forces may be detected at two or more keyboard locations of the GUI.

Other innovative aspects of the subject matter described in this disclosure may be implemented in a method of providing a graphical user interface (GUI). In some examples, the method may involve controlling (for example, by a control system) a display system to present the GUI, the GUI may include a representation of a keyboard in at least a portion of an active force sensor area of a force sensor system. The method may involve receiving (for example, by the control system), from a touch sensor system, an indication of a touch in a keyboard location of the GUI and receiving, from the force sensor system, an indication of an applied force. The method may involve determining (for example, by the control system) whether the applied force is at or above a first force threshold. The method may involve controlling (for example, by the control system) keyboard functionality corresponding with the GUI according to whether the applied force is at or above the first force threshold. In some examples, the indication of the applied force may be received at the keyboard location.

In some examples, the GUI may include a suggested word area in which suggested words are presented. In some such examples, controlling the keyboard functionality may involve selecting a suggested word responsive to determining that an applied force at a keyboard location outside of the suggested word area is at or above the first force threshold. In some examples, the suggested word may be one of a plurality of suggested words. In some such examples, controlling the keyboard functionality may involve scrolling between suggested words of the plurality of suggested words responsive to a detected digit rotation, a detected digit distortion or a detected digit swipe in one or more keyboard locations outside of the suggested word area.

According to some examples, the GUI may include a symbol presentation area in which symbols corresponding to selected key images of the keyboard are presented. In some such examples, each selected key image may correspond with a keyboard location. According to some examples, the symbols may include letters. In some such examples, the method may involve determining whether a letter presented in the symbol presentation area is the first letter of a word. In some such examples, controlling the keyboard functionality may involve changing the case of the letter responsive to determining that the letter is the first letter of the word and that the applied force is at or above the first force threshold. In some examples, controlling the keyboard functionality may involve adding one or more spaces after the letter responsive to determining that the letter is not the first letter of a word and that the applied force is at or above the first force threshold. In some examples, the keyboard may not include a key image specifically for changing the case of a letter in the symbol presentation area.

In some examples, controlling the keyboard functionality may involve changing symbols corresponding to one or more key images of the keyboard. In some such examples, changing the symbols corresponding to the one or more key images of the keyboard may involve substituting one or more alphabetical key images for one or more non-alphabetical key images, or vice versa.

According to some examples, changing the symbols corresponding to the one or more key images of the keyboard may involve substituting first symbols corresponding to a first language for second symbols corresponding to a second language. In some such examples, the keyboard may not include a key image specifically for changing symbols corresponding to one or more key images of the keyboard.

In some examples, the method may involve determining whether the applied force is at or above a second force threshold. In some such examples, the method may involve controlling keyboard functionality according to whether the applied force is at or above the second force threshold.

According to some examples, the method may involve determining whether each applied force of a plurality of applied forces is at or above the first force threshold. In some such examples, the method may involve controlling keyboard functionality according to whether each applied force of the plurality of applied forces is at or above the first force threshold. In some such examples, the plurality of applied forces may be detected at two or more keyboard locations of the GUI.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon.

For example, the software may include instructions for controlling one or more devices to perform a method. According to some examples, the method may involve controlling (for example, by a control system) a display system to present the GUI, the GUI may include a representation of a keyboard in at least a portion of an active force sensor area of a force sensor system. The method may involve receiving (for example, by the control system), from a touch sensor system, an indication of a touch in a keyboard location of the GUI and receiving, from the force sensor system, an indication of an applied force. The method may involve determining (for example, by the control system) whether the applied force is at or above a first force threshold. The method may involve controlling (for example, by the control system) keyboard functionality corresponding with the GUI according to whether the applied force is at or above the first force threshold. In some examples, the indication of the applied force may be received at the keyboard location.

In some examples, the GUI may include a suggested word area in which suggested words are presented. In some such examples, controlling the keyboard functionality may involve selecting a suggested word responsive to determining that an applied force at a keyboard location outside of the suggested word area is at or above the first force threshold. In some examples, the suggested word may be one of a plurality of suggested words. In some such examples, controlling the keyboard functionality may involve scrolling between suggested words of the plurality of suggested words responsive to a detected digit rotation, a detected digit distortion or a detected digit swipe in one or more keyboard locations outside of the suggested word area.

According to some examples, the GUI may include a symbol presentation area in which symbols corresponding to selected key images of the keyboard are presented. In some such examples, each selected key image may correspond with a keyboard location. According to some examples, the symbols may include letters. In some such examples, the method may involve determining whether a letter presented in the symbol presentation area is the first letter of a word. In some such examples, controlling the keyboard functionality may involve changing the case of the letter responsive to determining that the letter is the first letter of the word and that the applied force is at or above the first force threshold. In some examples, controlling the keyboard functionality may involve adding one or more spaces after the letter responsive to determining that the letter is not the first letter of a word and that the applied force is at or above the first force threshold. In some examples, the keyboard may not include a key image specifically for changing the case of a letter in the symbol presentation area.

In some examples, controlling the keyboard functionality may involve changing symbols corresponding to one or more key images of the keyboard. In some such examples, changing the symbols corresponding to the one or more key images of the keyboard may involve substituting one or more alphabetical key images for one or more non-alphabetical key images, or vice versa.

According to some examples, changing the symbols corresponding to the one or more key images of the keyboard may involve substituting first symbols corresponding to a first language for second symbols corresponding to a second language. In some such examples, the keyboard may not include a key image specifically for changing symbols corresponding to one or more key images of the keyboard.

In some examples, the method may involve determining whether the applied force is at or above a second force threshold. In some such examples, the method may involve controlling keyboard functionality according to whether the applied force is at or above the second force threshold.

According to some examples, the method may involve determining whether each applied force of a plurality of applied forces is at or above the first force threshold. In some such examples, the method may involve controlling keyboard functionality according to whether each applied force of the plurality of applied forces is at or above the first force threshold. In some such examples, the plurality of applied forces may be detected at two or more keyboard locations of the GUI.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 shows a block diagram that includes example components of an apparatus according to some disclosed implementations.

FIGS. 2A and 2B show examples of an apparatus configured to perform at least some disclosed methods.

FIG. 3 shows a flow diagram that presents examples of operations according to some disclosed methods.

FIG. 4 shows an example of an apparatus that is displaying a keyboard-based GUI that includes a suggested word area.

FIGS. 5A, 5B, 5C and 5D show examples of force sensors that are integrated into the circuitry of ultrasonic fingerprint sensors.

FIGS. 6A and 6B show images that correspond with signals provided by an ultrasonic fingerprint sensor for a light finger touch and a heavy finger touch, respectively.

FIGS. 7A and 7B show images that represent fingerprint image data corresponding to lateral (e.g., left- and right-directed) finger forces.

FIG. 8 shows images that represent exertions of a finger.

FIG. 9 shows images that represent digit distortions.

FIG. 10 shows images that represent movement of a fingerprint contact area.

FIG. 11 shows images that represent rotational movement of a digit.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various devices are configured to present a GUI that includes an image representing a keyboard and to provide related keyboard functionality. Such a keyboard image will generally include a symbol presentation area in which key images including symbols, such as letters or other characters, are presented. In some English-language examples, the key images of the symbol presentation area may include key images corresponding to keys of a QWERTY keyboard. Keyboards intended for other languages may include more or fewer key images than a representation of a QWERTY keyboard. A user may interact with the keyboard-based GUI, for example by touching the key images, in order to provide input to the device.

Many devices, such as cellular telephones and other mobile devices, have limited space in which to present a keyboard-type GUI. This size constraint presents challenges for providing an optimal user experience. For example, this size constraint requires a tradeoff between the number of key images presented on the keyboard, and the corresponding number of available symbols and functions, and the sizes of these key images. Moreover, some keyboard functions of previously-deployed keyboard GUIs require a user to lift or otherwise re-position one or more fingers from keyboard images, such as keyboard images corresponding to letters or similar symbols. Re-positioning the finger(s) can slow a user's typing speed. (The word “finger” as used herein may correspond to any digit, including a thumb.) Such drawbacks may lead to a poor user experience with keyboard GUIs that are presented on mobile telephones and other relatively small devices.

Some disclosed examples may provide keyboard functionality responsive to a detected level of force corresponding with a user's interaction with a keyboard GUI. For example, one or more applied forces (such as a force or a pattern of forces that are above a force threshold) can be used to indicate the end of a word, for example to indicate that a space should be added after the word, without requiring the user to lift a finger from the key image corresponding to the last letter of the word. Such examples do not require the user to re-position a finger to touch a space key image, etc. In some examples, one or more applied forces can be used to indicate the end of a sentence, for example to indicate that a period and one or more spaces should be added to a current word, without requiring the user to lift a finger from the key image corresponding to the last letter of the word. Such examples do not require the user to re-position a finger to touch a space key image, etc. In some examples, the GUI may include a suggested word area in which suggested words are presented. According to some such examples, a suggested word may be selected responsive to determining that an applied force at a keyboard location outside of the suggested word area is at or above the force threshold, without requiring the user to re-position a finger to touch a suggested word. In some examples, the applied force may correspond to a detected digit rotation, digit distortion, digit swipe, etc.

Particular implementations of the subject matter described in this disclosure may be implemented to realize one or more of the following potential advantages. Some disclosed examples provide various kinds of keyboard functionality that allows a user to maintain the user's current finger position(s), for example to allow a finger to remain on a particular key image in which a symbol, such as a letter, is presented. Accordingly, various kinds of keyboard functionality may be provided without requiring the user to lift a finger from the key image to re-position a finger to touch a space key image, to touch an image corresponding to a suggested word, etc. Such implementations may provide a higher level of user satisfaction and may allow the user to interact more efficiently with the GUI. According to some such implementations, a user may be able to achieve a relatively higher typing speed as a result of the increased efficiency of the user's interactions with the GUI. Some implementations may provide a relatively more efficient keyboard-type GUI than prior keyboard-type GUIs, by avoiding the need to create and display additional key images that correspond with various types of keyboard functionality, thereby retaining more space for the key images that are presented. Many users may find relatively larger key images easier to interact with than relatively smaller key images.

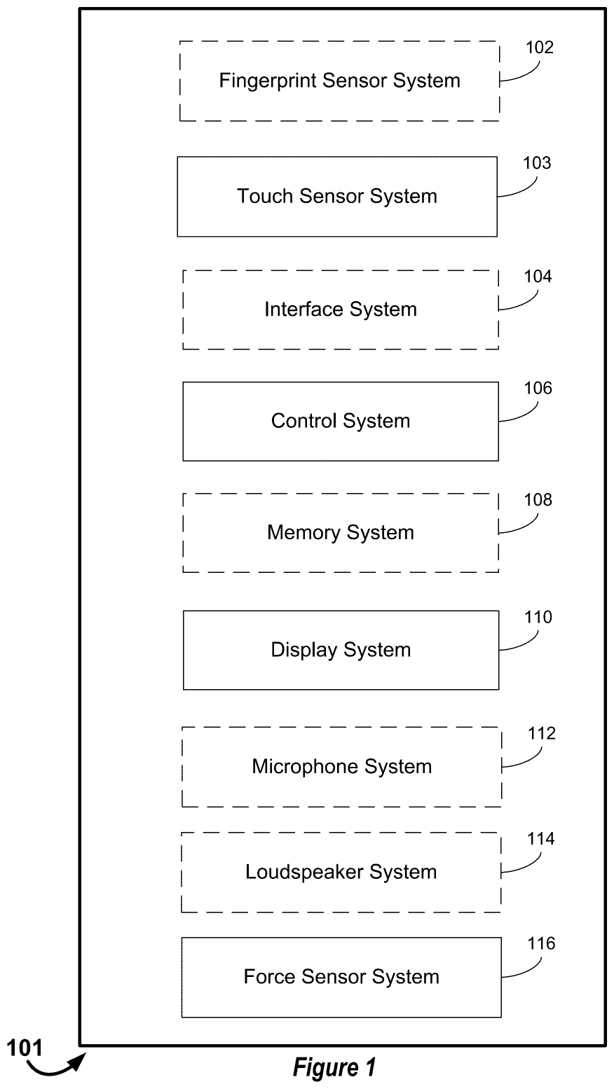

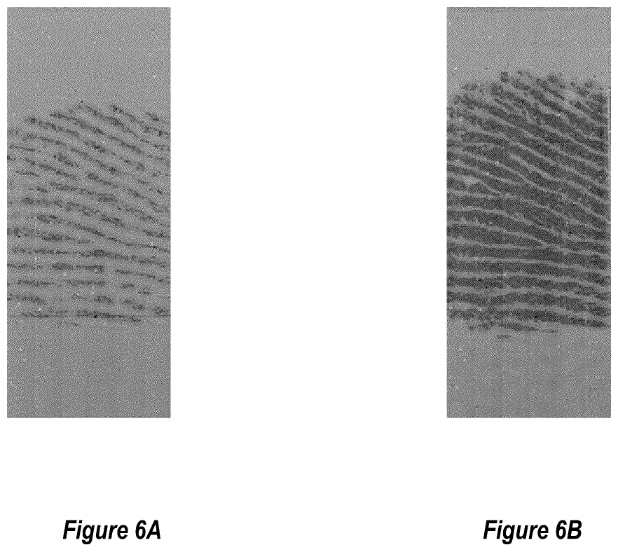

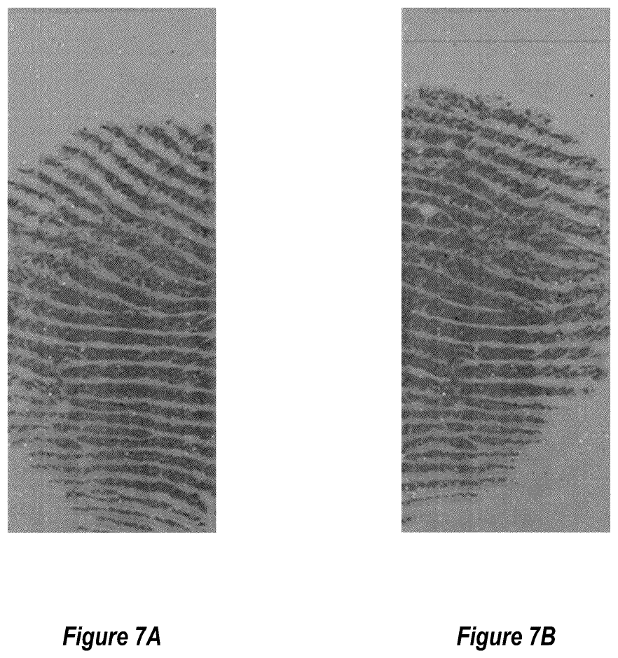

FIG. 1 is a block diagram that shows example components of an apparatus according to some disclosed implementations. In this example, the apparatus 101 includes a touch sensor system 103, a control system 106, a display system 110 and a force sensor system 116. Some implementations may include a fingerprint sensor system 102, an interface system 104, a memory system 108, a microphone system 112, a loudspeaker system 114, or combinations thereof. Some alternative implementations may not include a force sensor system 116. Some such implementations include a fingerprint sensor system 102 and a control system configured to make finger force estimations according to fingerprint sensor data received from the fingerprint sensor system 102. Some examples are described herein with reference to FIGS. 6A-7B.

According to some examples, the fingerprint sensor system 102, if present, may be, or may include, an ultrasonic fingerprint sensor. Alternatively, or additionally, in some implementations the fingerprint sensor system 102 may be, or may include, another type of fingerprint sensor, such as an optical fingerprint sensor, a capacitive fingerprint sensor, a thermal fingerprint sensor, etc. In some examples, an ultrasonic version of the fingerprint sensor system 102 may include an ultrasonic receiver and a separate ultrasonic transmitter. In some such examples, the ultrasonic transmitter may include an ultrasonic plane-wave generator. However, various examples of ultrasonic fingerprint sensors are disclosed herein, some of which may include a separate ultrasonic transmitter and some of which may not. For example, in some implementations, the fingerprint sensor system 102 may include a piezoelectric receiver layer, such as a layer of polyvinylidene fluoride PVDF polymer or a layer of polyvinylidene fluoride-trifluoroethylene (PVDF-TrFE) copolymer. In some implementations, a separate piezoelectric layer may serve as the ultrasonic transmitter. In some implementations, a single piezoelectric layer may serve as both a transmitter and a receiver. The fingerprint sensor system 102 may, in some examples, include an array of ultrasonic transducer elements, such as an array of piezoelectric micromachined ultrasonic transducers (PMUTs), an array of capacitive micromachined ultrasonic transducers (CMUTs), etc. In some such examples, PMUT elements in a single-layer array of PMUTs or CMUT elements in a single-layer array of CMUTs may be used as ultrasonic transmitters as well as ultrasonic receivers.

Data received from the fingerprint sensor system 102 may sometimes be referred to herein as “fingerprint sensor data,” “fingerprint image data,” etc., whether or not the received data corresponds to an actual digit or another object from which the fingerprint sensor system 102 has received data. Such data will generally be received from the fingerprint sensor system in the form of electrical signals. Accordingly, without additional processing such image data would not necessarily be perceivable by a human being as an image. As noted elsewhere herein, the word “finger” as used herein may correspond to any digit, including a thumb. Accordingly, a thumbprint is a type of fingerprint.

The touch sensor system 103 may be, or may include, a resistive touch sensor system, a surface capacitive touch sensor system, a projected capacitive touch sensor system, a surface acoustic wave touch sensor system, an infrared touch sensor system, or any other suitable type of touch sensor system. In some implementations, the area of the touch sensor system 103 may extend over most or all of a display portion of the display system 110.

In some examples, the interface system 104 may include a wireless interface system. In some implementations, the interface system 104 may include a user interface system, one or more network interfaces, one or more interfaces between the control system 106 and the fingerprint sensor system 102, one or more interfaces between the control system 106 and the touch sensor system 103, one or more interfaces between the control system 106 and the memory system 108, one or more interfaces between the control system 106 and the display system 110, one or more interfaces between the control system 106 and the microphone system 112, one or more interfaces between the control system 106 and the loudspeaker system 114, one or more interfaces between the control system 106 and the force sensor system 116 and/or one or more interfaces between the control system 106 and one or more external device interfaces (e.g., ports or applications processors).

The interface system 104 may be configured to provide communication (which may include wired or wireless communication, electrical communication, radio communication, etc.) between components of the apparatus 101. In some such examples, the interface system 104 may be configured to provide communication between the control system 106 and the fingerprint sensor system 102. According to some such examples, the interface system 104 may couple at least a portion of the control system 106 to the fingerprint sensor system 102 and the interface system 104 may couple at least a portion of the control system 106 to the touch sensor system 103, e.g., via electrically conducting material (e.g., via conductive metal wires or traces. According to some examples, the interface system 104 may be configured to provide communication between the apparatus 101 and other devices and/or human beings. In some such examples, the interface system 104 may include one or more user interfaces, haptic feedback devices, etc. The interface system 104 may, in some examples, include one or more network interfaces and/or one or more external device interfaces (such as one or more universal serial bus (USB) interfaces or a serial peripheral interface (SPI)).

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. In this example, the control system 106 is configured for communication with, and for controlling, the fingerprint sensor system 102. In implementations wherein the apparatus includes a touch sensor system 103, the control system 106 may be configured for communication with, and for controlling, the touch sensor system 103. In implementations wherein the apparatus includes a memory system 108 that is separate from the control system 106, the control system 106 also may be configured for communication with the memory system 108. In implementations wherein the apparatus includes a display system 110, the control system 106 may be configured for communication with, and for controlling, the display system 110. In implementations wherein the apparatus includes a microphone system 112, the control system 106 may be configured for communication with, and for controlling, the microphone system 112. In implementations wherein the apparatus includes an loudspeaker system 114, the control system 106 may be configured for communication with, and for controlling, the loudspeaker system 114. According to some examples, the control system 106 may include one or more dedicated components that are configured for controlling the fingerprint sensor system 102, the touch sensor system 103, the memory system 108, the display system 110, the microphone system 112 and/or the loudspeaker system 114.

Some examples of the apparatus 101 may include dedicated components that are configured for controlling at least a portion of the fingerprint sensor system 102 (and/or for processing fingerprint image data received from the fingerprint sensor system 102). Although the control system 106 and the fingerprint sensor system 102 are shown as separate components in FIG. 1, in some implementations at least a portion of the control system 106 and at least a portion of the fingerprint sensor system 102 may be co-located. For example, in some implementations one or more components of the fingerprint sensor system 102 may reside on an integrated circuit or “chip” of the control system 106. According to some implementations, functionality of the control system 106 may be partitioned between one or more controllers or processors, such as between a dedicated sensor controller and an applications processor (also referred to herein as a “host” processor) of an apparatus, such as a host processor of a mobile device. In some such implementations, at least a portion of the host processor may be configured for fingerprint image data processing, determination of whether currently-acquired fingerprint image data matches previously-obtained fingerprint image data (such as fingerprint image data obtained during an enrollment process), etc.

In some examples, the memory system 108 may include one or more memory devices, such as one or more RAM devices, ROM devices, etc. In some implementations, the memory system 108 may include one or more computer-readable media, storage media and/or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In this example the apparatus 101 includes a display system 110, which may include one or more displays. In some examples, the display system 110 may be, or may include, a light-emitting diode (LED) display, such as an organic light-emitting diode (OLED) display. In some such examples, the display system 110 may include layers, which may be referred to collectively as a “display stack.”

In some implementations, the apparatus 101 may include a microphone system 112. The microphone system 112 may include one or more microphones, one or more types of microphones, or combinations thereof.

According to some implementations, the apparatus 101 may include an loudspeaker system 114. The loudspeaker system 114 may include one or more loudspeakers, one or more types of loudspeakers, or combinations thereof.

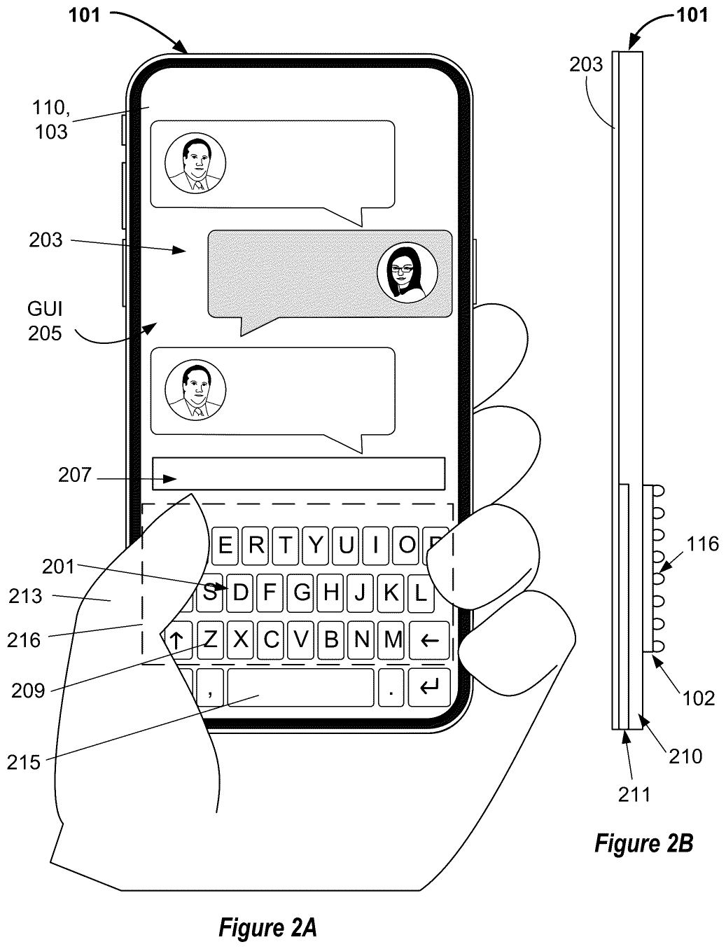

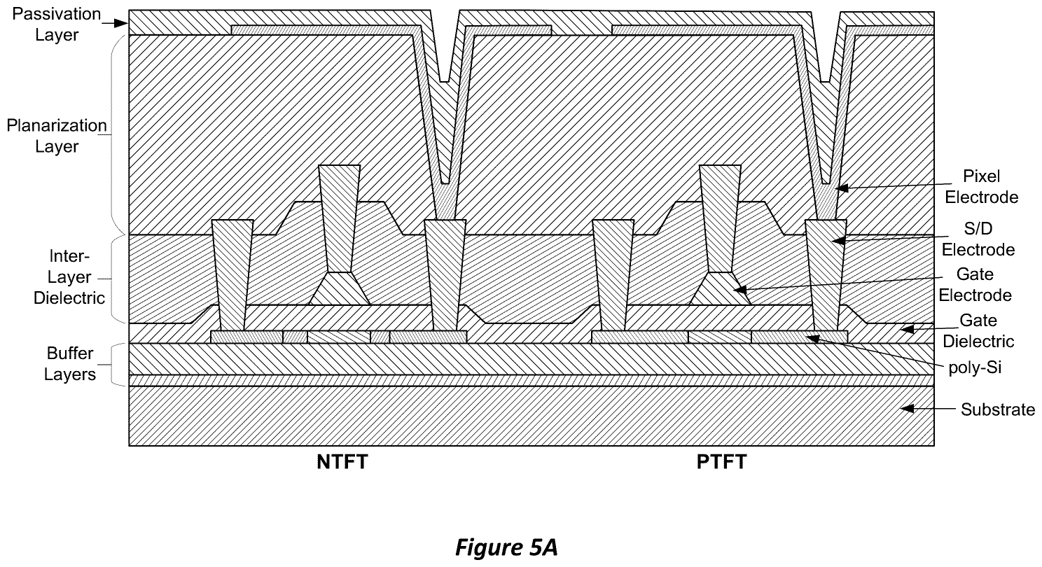

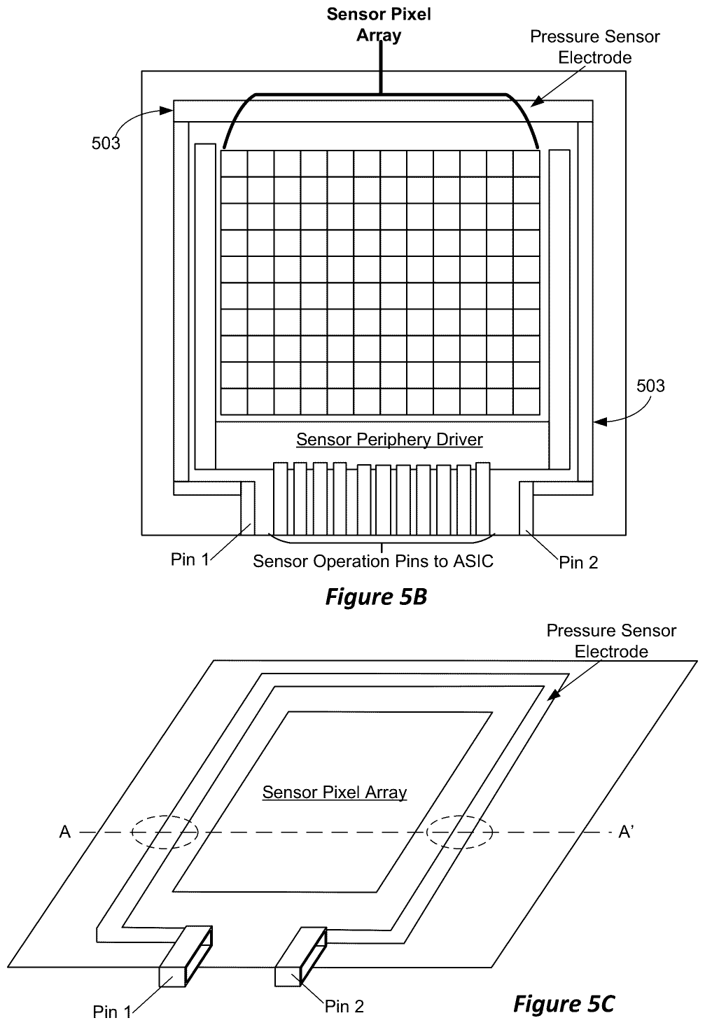

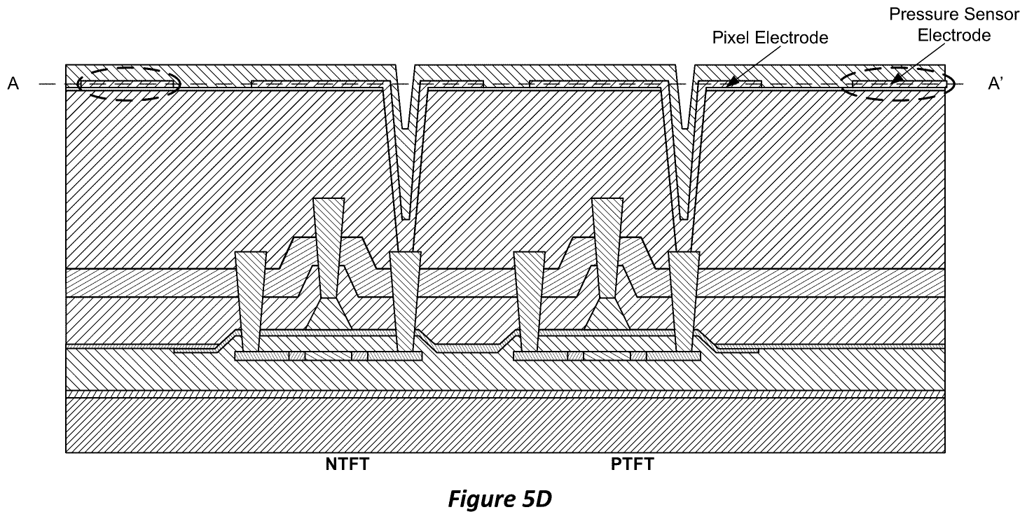

The force sensor system 116 may be, or may include, a piezo-resistive sensor, a capacitive sensor, a thin film sensor (for example, a polymer-based thin film sensor), another type of suitable force sensor, or combinations thereof. If the force sensor system 116 includes a piezo-resistive sensor, the piezo-resistive sensor may include silicon, metal, polysilicon, glass, or combinations thereof. The ultrasonic fingerprint sensor 102 and the force sensor system 116 may, in some implementations, be mechanically coupled. In some such examples, the force sensor system 116 may be integrated into circuitry of the ultrasonic fingerprint sensor 102. Some relevant examples are described herein with reference to FIGS. 2B and 5A-5D. However, in other implementations the force sensor system 116 may be separate from the ultrasonic fingerprint sensor 102. The ultrasonic fingerprint sensor 102 and the force sensor system 116 may, in some examples, be indirectly coupled. For example, the ultrasonic fingerprint sensor 102 and the force sensor system 116 each may be coupled to a portion of the apparatus 101. In some such examples, the ultrasonic fingerprint sensor 102 and the force sensor system 116 each may be coupled to a portion of the control system.

The apparatus 101 may be used in a variety of different contexts, some examples of which are disclosed herein. For example, in some implementations a mobile device may include at least a portion of the apparatus 101. In some implementations, a wearable device may include at least a portion of the apparatus 101. The wearable device may, for example, be a bracelet, an armband, a wristband, a ring, a headband or a patch. In some implementations, the control system 106 may reside in more than one device. For example, a portion of the control system 106 may reside in a wearable device and another portion of the control system 106 may reside in another device, such as a mobile device (e.g., a smartphone). The interface system 104 also may, in some such examples, reside in more than one device.

FIGS. 2A and 2B show examples of an apparatus configured to perform at least some disclosed methods. As with other disclosed examples, the types, numbers and arrangements of elements that are shown in FIGS. 2A and 2B are merely presented by way of example. Other examples may include different types of elements, numbers of elements, arrangements of elements, or combinations thereof.

In this implementation, the apparatus 101 is an instance of the apparatus 101 of FIG. 1. According to this implementation, the apparatus 101 is a mobile device that includes a fingerprint sensor system 102, a touch sensor system 103, a control system 106 (not shown), a display system 110 and a force sensor system 116.

In this example, FIG. 2A shows a top view of the apparatus 101 and FIG. 2B shows a cross-sectional view of selected components of the apparatus 101. The GUI 205 shown in FIG. 2A includes a keyboard representation 201 (also referred to herein as “a representation of a keyboard”) and a text message display area 203. In this example, the keyboard representation 201 includes a plurality of key images 209, some of which include symbol representations, such as letter images and punctuation images, some of which include arrow images corresponding to various functions and one of which is a spacebar image.

According to this example, the GUI 205 also includes a symbol presentation area 207 in which symbols corresponding to selected key images of the keyboard representation 201 are presented when touched by a user, for example when touched by the user's thumb 213. In this manner, a user may compose a text message by selecting key images of the keyboard representation 201. According to this example, each selected key image corresponds with a keyboard location of the keyboard representation 201 in which the key image is displayed. As used herein, the term “keyboard location” refers generally to an area in which a key image is displayed.

In this example, FIG. 2B shows a cross-section of a keyboard area 211 that corresponds with the area in which the keyboard representation 201 is presented on a display panel 210 of the display system 110. According to this example, the cross-section of the keyboard area 211 is displayed differently from the remainder of the display panel 210 merely to indicate the extent of the keyboard area 211, not to indicate that the keyboard area 211 is made of different material than the rest of the display panel 210.

According to this particular example, the fingerprint sensor system 102 is an ultrasonic fingerprint sensor and incorporates the force sensor system 116. In some alternative implementations, the force sensor system 116 may be separate from the fingerprint sensor system 102. According to some such alternative implementations, the fingerprint sensor system 102 may be, or may include, an optical fingerprint sensor, a capacitive fingerprint sensor or another type of fingerprint sensor.

In this example, the active force sensor area 216 shown in FIG. 2A corresponds with an active portion of the force sensor system 116 that is shown in FIG. 2B. As used herein, the “active portion” of the force sensor system 116 refers to the portion of the force sensor system 116 that is configured to detect forces. Other portions of the force sensor system 116 may, for example, provide electrical connectivity with a power source, provide electrical connectivity with a control system, etc., and may not directly provide force-sensing functionality. (Similarly, as used herein, an “active portion” of a fingerprint sensor system 102 refers to the portion of the fingerprint sensor system 102 that is configured to obtain fingerprint image data, such as an array of fingerprint sensor pixels. Other portions of the fingerprint sensor system 102 may, for example, provide electrical connectivity with a power source, provide electrical connectivity with a control system, etc., and may not directly provide fingerprint imaging functionality.) In this example, the active force sensor area 216 and the keyboard representation 201 overlap. According to this particular example, the keyboard representation 201 (for example the portion of the keyboard representation 201 that includes the space bar 215) extends beyond the active force sensor area 216. In other examples, the active force sensor area 216 may extend beyond the keyboard representation 201, whereas in yet other examples, the active force sensor area 216 may be co-extensive with, or substantially co-extensive with (for example +/−5%, +/−10%, etc.) the keyboard representation 201.

According to this example, the touch sensor system 103 includes a touch screen 203 proximate a first side of the display panel 210 of the display system 110. In this example, the active force sensor area 216 of the force sensor system 116 is proximate a second side of the display panel 210. As noted elsewhere, other examples may include different types of elements, numbers of elements, arrangements of elements, or combinations thereof.

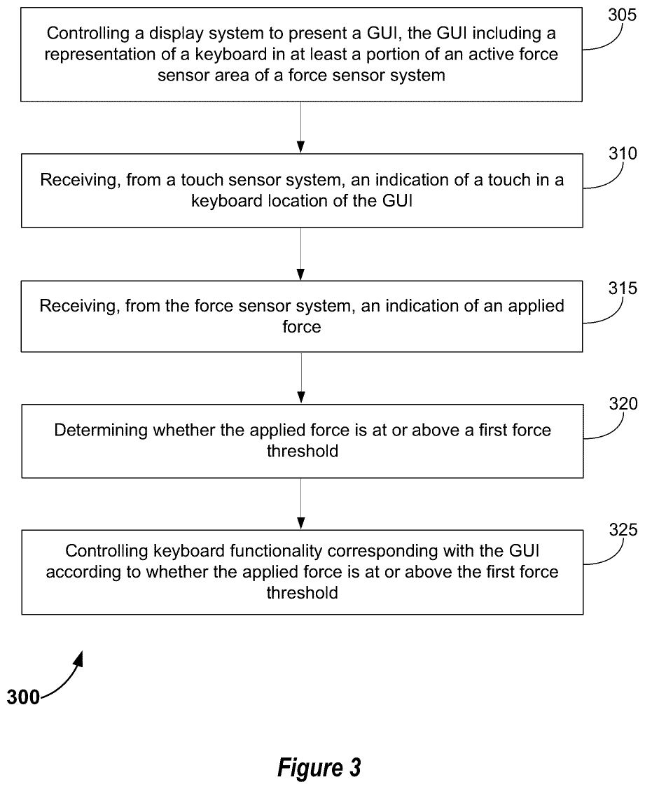

FIG. 3 shows a flow diagram that presents examples of operations according to some disclosed methods. The blocks of FIG. 3 may be performed by an apparatus that includes at least a fingerprint sensor system and a control system. The blocks of FIG. 3 may, for example, be performed by the apparatus 101 of FIG. 1, FIG. 2A or FIG. 2B, or by a similar apparatus. For example, in some implementations the control system 106 of FIG. 1 may be configured to perform, at least in part, the operations that are described herein with reference to FIG. 3. In some examples, the apparatus may be a mobile device, such as a cellular telephone. However, in other examples, the apparatus may be another type of device, such as a tablet, a laptop, an automobile or component thereof, a wearable device, etc. As with other methods disclosed herein, the methods outlined in FIG. 3 may include more or fewer blocks than indicated. Moreover, the blocks of methods disclosed herein are not necessarily performed in the order indicated. In some implementations, one or more blocks may be performed concurrently.

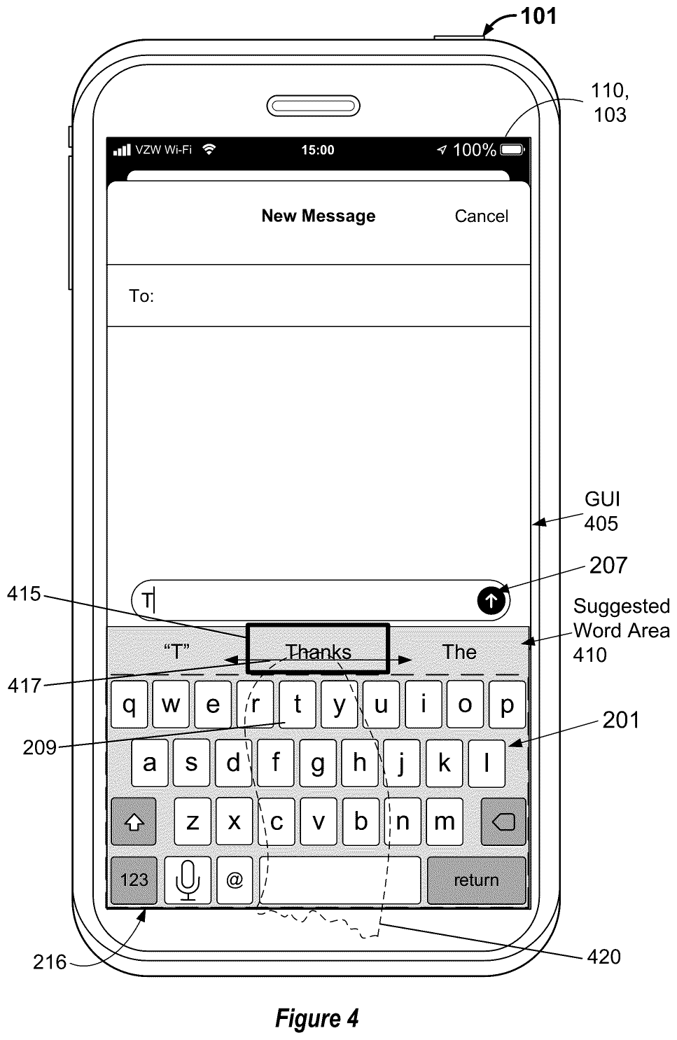

According to this example, method 300 is a method of providing a graphical user interface (GUI). In this example, block 305 involves controlling a display system to present the GUI. According to this example, the GUI includes a representation of a keyboard in at least a portion of an active force sensor area of a force sensor system. Examples of such GUIs are provided in FIGS. 2A and 4. However, other types and arrangements of GUIs are contemplated by the inventors. For example, some contemplated alternative keyboard GUIs may lack a key image corresponding to a space bar, may lack a key image corresponding to an upper/lower case control, etc., because such functionality may be provided according to force-based examples such as those disclosed herein.

In this example, block 310 involves receiving, from a touch sensor system, an indication of a touch in a keyboard location of the GUI. According to some such examples, block 310 may involve receiving, from the touch panel 203 of the touch sensor system 103 that is shown in FIGS. 2A and 2B, an indication of the touch in the keyboard representation 201 of the GUI 205.

According to this example, block 315 involves receiving, from the force sensor system, an indication of an applied force. According to some such examples, block 315 may involve receiving the indication of the applied force at the keyboard location of block 310. However, in some alternative examples, block 315 may involve receiving the indication of the applied force at another keyboard location.

In this example, block 320 involves determining whether the applied force is at or above a first force threshold. According to some examples, the first force threshold may be determined during a set-up process. For example, the set-up process may involve presenting one or more GUIs that include instructions for user to press with varying degrees of force on a surface of the apparatus 101 corresponding with an active force sensor area, corresponding with a fingerprint sensor area, or both. The user may, in some examples, be prompted to establish one or more force thresholds that will trigger keyboard functionality for a keyboard-based GUI. In other examples, the first force threshold (or at least a preliminary or default first force threshold) may be determined prior to a time during which the apparatus 101 is placed on the market, for example as part of a factory calibration process.

According to this example, block 325 involves controlling keyboard functionality corresponding with the GUI according to whether the applied force is at or above the first force threshold. In some such examples, the GUI may include a symbol presentation area (such as the symbol presentation area 207 that is shown in FIG. 2B) in which symbols corresponding to selected key images of the keyboard are presented. According to some such examples, each selected key image may correspond with a keyboard location (such as the area occupied by an image of a key of the keyboard representation).

In some such examples, the symbols may include letters. According to some such examples, the method 300 may involve determining whether a letter presented in the symbol presentation area is the first letter of a word. This determination may be made, for example, according to whether there is a space before the letter in the symbol presentation area 207, according to whether the letter is the first letter of a message, etc. In some examples, controlling the keyboard functionality in block 325 may involve changing the case of the letter (for example, from lower case to upper case) responsive to determining that the letter is the first letter of the word and that the applied force is at or above the first force threshold. According to some such examples, the keyboard may not include a key image specifically for changing the case of a letter in the symbol presentation area. Therefore, such implementations can present a keyboard GUI more efficiently, either by presenting relatively fewer key images, by enlarging one or more presented key images, or combinations thereof.

However, in some instances it may be determined that a letter in the symbol presentation area is not the first letter of a word. In some such examples, controlling the keyboard functionality in block 325 may involve adding one or more spaces after a letter in the symbol presentation area responsive to determining that the letter is not the first letter of a word and that the applied force is at or above the first force threshold. In some such instances, a user may have caused the user's finger to apply the force with the intention of causing one or more spaces to be added after a letter in the symbol presentation area. According to some such examples, the keyboard may not include a “spacebar” key image for adding one or more spaces in the symbol presentation area. Therefore, such implementations can present a keyboard GUI more efficiently, either by presenting relatively fewer key images, by enlarging one or more presented key images, or combinations thereof.

In some examples, controlling the keyboard functionality in block 325 may involve changing symbols corresponding to one or more key images of the keyboard. In some such examples, changing the symbols corresponding to the one or more key images of the keyboard may involve substituting one or more alphabetical key images for one or more non-alphabetical key images, or vice versa. According to some examples, changing the symbols corresponding to the one or more key images of the keyboard may involve substituting first symbols corresponding to a first language for second symbols corresponding to a second language. According to some such examples, changing the symbols corresponding to the one or more key images of the keyboard may involve substituting letters corresponding to the English language to letters of the Hindi alphabet, or vice versa. Other examples may involve other languages and corresponding letters or symbols.

In some examples, a first force pattern (such as one finger press above the first force threshold but below a second force threshold, a finger rotation in a first direction, a finger swipe in a first direction, a first type of finger distortion, combinations thereof, etc.) may trigger substituting one or more alphabetical key images for one or more non-alphabetical key images, or vice versa. According to some examples, a second force pattern (such as one finger press above the second force threshold, two finger presses above the first force threshold but below a second force threshold, three finger presses above the first force threshold but below a second force threshold, a finger rotation in a second direction, a finger swipe in a second direction, a second type of finger distortion, combinations thereof, etc.) may trigger substituting first symbols corresponding to the first language for second symbols corresponding to the second language.

According to some examples, the keyboard may not include a key image specifically for substituting alphabetical key images for non-alphabetical key images. Alternatively, or additionally, some examples, the keyboard may not include a key image specifically for substituting first symbols corresponding to the first language for second symbols corresponding to the second language. Therefore, such implementations can present a keyboard GUI more efficiently, either by presenting relatively fewer key images, by enlarging one or more presented key images, or combinations thereof.

As suggested by the foregoing references to a second force threshold, some implementations of method 300 may involve determining whether the applied force is at or above a second force threshold. Some such methods may involve controlling keyboard functionality according to whether the applied force is at or above the second force threshold. Some implementations of method 300 may involve determining whether each applied force of a plurality of applied forces is at or above the first force threshold. Some such methods may involve controlling keyboard functionality according to whether each applied force of the plurality of applied forces is at or above the first force threshold. Some methods may involve controlling keyboard functionality according to whether one or more applied forces is at or above the first force threshold, but below the second threshold. Alternatively, or additionally, some methods may involve controlling keyboard functionality according to whether one or more applied forces is at or above the second threshold. In some examples, one or more of the applied forces may be applied in the same keyboard location of the GUI. However, in other examples, one or more of the applied forces may be applied in two or more keyboard locations of the GUI.

In some examples, the GUI may include a suggested word area in which suggested words are presented, for example responsive to one or more symbols that are currently presented in a symbol presentation area. In some such examples, controlling the keyboard functionality in block 325 may involve selecting a suggested word responsive to determining that an applied force at a keyboard location outside of the suggested word area is at or above the first force threshold. In some examples, the suggested word may be one of a plurality of suggested words. In some such examples, controlling the keyboard functionality in block 325 may involve scrolling between suggested words of the plurality of suggested words responsive to a detected digit rotation, a detected digit distortion, a detected digit swipe, a detected force pattern, or combinations thereof, in one or more keyboard locations outside of the suggested word area. Some examples of detecting digit rotations, digit distortions and digit swipes are disclosed herein, for example in FIGS. 6A-11 and the corresponding descriptions.

FIG. 4 shows an example of an apparatus that is displaying a keyboard-based GUI that includes a suggested word area. In this implementation, the apparatus 101 is an instance of the apparatus 101 of FIG. 1. According to this implementation, the apparatus 101 is a mobile device that includes a touch sensor system 103, a control system 106 (not shown), a display system 110 and a force sensor system 116, an active force sensor area 216 of which is outlined in a dashed rectangle in FIG. 4.

As with other disclosed examples, the types, numbers and arrangements of elements that are shown in FIG. 4 are merely presented by way of example. Other examples may include different types of elements, numbers of elements, arrangements of elements, or combinations thereof. In some examples, the apparatus 101 may include a fingerprint sensor system 102, which may or may not be associated with the force sensor system 116, depending on the particular implementation.

In this example, the GUI 405 includes a keyboard representation 201 and a symbol presentation area 207 in which symbols corresponding to selected key images of the keyboard representation 201 are presented when touched by a user. In this example, the active force sensor area 216 is co-extensive with, or substantially co-extensive with, the keyboard representation 201.

According to this example, the GUI 405 also includes a suggested word area 410. In some examples, the suggested word area 410 may only be presented when symbols corresponding to selected key images of the keyboard representation 201 are being presented in the symbol presentation area 207.

In some examples, a control system of the apparatus 101 may be configured to control the display system 110 to scroll between suggested words of the suggested word area 410 responsive to a detected digit rotation, a detected digit distortion, a detected digit swipe, a detected force pattern, or combinations thereof, in one or more keyboard locations outside of the suggested word area. Some examples of detecting digit rotations, digit distortions and digit swipes are described below with reference to FIGS. 6A-11. In this example, the control system is configured to control the display system 110 to indicate a scrolling operation by forming a dark outline around between suggested words of the suggested word area 410, such as the selection rectangle 415 that is shown around the word “Thanks” in FIG. 4. In some such examples, responsive to a detected digit rotation, a detected digit distortion or a detected digit swipe in one or more keyboard locations outside of the suggested word area, the control system may control the display system 110 to indicate a scrolling operation by moving the selection rectangle 415 in either direction of the arrow 417 that is shown in FIG. 4, depending on the direction of the detected digit rotation, digit distortion or digit swipe.

The suggested words shown in FIG. 4 are being presented in the suggested word area 410 responsive to a detected touch on the key image 209 corresponding to the letter “t.” In this example, a user's finger 420 is pressing on the key image 209 corresponding to the letter “t.” According to some examples, responsive to a detected digit rotation, a detected digit distortion, a detected digit swipe, or combinations thereof, of the finger 420 in the keyboard location corresponding to the letter “t,” the control system may control the display system 110 to indicate a scrolling operation by moving the selection rectangle 415 in either direction of the arrow 417 that is shown in FIG. 4, depending on the direction of the detected digit rotation, digit distortion or digit swipe. Accordingly, in such examples the user does not need to lift the finger 420 from the key image 209 corresponding to the letter “t” in order to select a suggested word, for example by touching the corresponding area of the suggested word area 410 as would have been required by previously-deployed keyboard GUI implementations.

FIGS. 5A, 5B, 5C and 5D show examples of force sensors that are integrated into the circuitry of ultrasonic fingerprint sensors. The implementations shown in FIGS. 5A, 5B, 5C and 5D are examples of the combined force sensor 116 and ultrasonic fingerprint sensor 102 that is shown in FIG. 2B. FIG. 5A shows a cross-section through one example of a metal-oxide-semiconductor field-effect transistor (MOSFET), which is a complementary metal-oxide-semiconductor (CMOS) in this example. In FIG. 5A, only a single n-type thin-film transistor (NTFT) and a single p-type TFT (PTFT) are shown. However, an actual ultrasonic fingerprint sensor having this type of structure would normally have many NTFT/PTFT pairs (for example, tens of thousands of NTFT/PTFT pairs).

Depending on the particular implementation, portions of different conductive layers of the stack shown in FIG. 5A may be used for a pressure sensor. In some examples, a portion of the pixel electrode layer may be used for the pressure sensor. In other examples, a portion of the source/drain (S/D) electrode layer may be used for the pressure sensor. According to some implementations, a portion of the gate electrode layer may be used for the pressure sensor. In some examples, a portion of the polycrystalline silicon (poly-Si) layer may be used for the pressure sensor. In some implementations, the poly-Si layer may include low-temperature polycrystalline silicon (LTPS).

FIG. 5B shows an example of a top view of an ultrasonic fingerprint sensor. In this example, the sensor pixel array and the sensor periphery driver each include multiple instances of a CMOS such as that shown in FIG. 5A. In this instance, a portion of the pixel electrode layer is configured to be used as a conductive part of a pressure sensor. According to this implementation, pin 1, pin 2 and the connected portions 503 of the pixel electrode layer are configured as a pressure sensor electrode. In this example the other pins, which are labeled in FIG. 5A as “sensor operation pins to ASIC,” may be used to connect the ultrasonic fingerprint sensor to a corresponding part of the control system. The control system may or may not include an ASIC depending on the particular implementation. According to some examples, the pressure sensor may also include a portion of one or more layers of piezoelectric material included in the ultrasonic fingerprint sensor.

FIG. 5C shows a perspective view of the ultrasonic fingerprint sensor shown in FIG. 5B. FIG. 5C also shows cross-section line A/A′, which corresponds with the cross-section shown in FIG. 5D.

FIG. 5D is a simplified cross-section through the ultrasonic fingerprint sensor shown in FIG. 5C. Like FIG. 5A, the example of FIG. 5D only shows a single NTFT/PTFT pair, whereas an actual ultrasonic fingerprint sensor having this type of structure would normally have many NTFT/PTFT pairs. The cross-section line A/A′ is shown traversing the pixel electrode layer and includes the pixel electrodes and the pressure sensor electrodes in this example. Alternative examples in which a portion of a deeper layer (such as a portion of the source/drain (S/D) electrode layer, a portion of the gate electrode layer or a portion of the poly-Si layer) is used to form the pressure sensor electrodes, the device may include vias to connect the deeper layers to a chip pin or other corresponding part of the control system.

In some implementations, a control system may be configured to estimate a level of force applied by a finger to a surface of the apparatus 101 that corresponds with an active fingerprint sensor area of the fingerprint sensor system 102. In some such implementations, the apparatus 101 may not have a force sensor system 116, but only a fingerprint sensor system 102. In some such implementations, fingerprint sensor-based force estimations may be made instead of receiving force sensor data from a force sensor system. For example, fingerprint sensor-based force estimations may be made in block 315 of FIG. 3, instead of receiving an indication of an applied force from a force sensor system. In such implementations, at least a portion of the keyboard representation may be displayed in the active fingerprint sensor area of the fingerprint sensor system 102.

In some alternative implementations in which an apparatus includes a control system configured to make fingerprint sensor-based force estimations in addition to a force sensor system, force sensor data from the force sensor system may be used (for example, at determined time intervals, responsive to detected events, or combinations thereof) in order to evaluate the accuracy of fingerprint sensor-based force estimations. Alternatively, or additionally, in some implementations in which an apparatus includes a control system configured to make fingerprint sensor-based force estimations in addition to a force sensor system, force sensor data from the force sensor system may be used to calibrate fingerprint sensor-based force estimations during a set-up process. In other implementations in which an apparatus includes a control system configured to make fingerprint sensor-based force estimations in addition to a force sensor system, fingerprint sensor-based force estimations may be used (for example, at determined time intervals, responsive to detected events, or combinations thereof) in order to evaluate whether a force sensor system is functioning properly.

Some examples of making fingerprint sensor-based force estimations are described in the following paragraphs. In these examples, the fingerprint sensor is an ultrasonic fingerprint sensor. However, a person of ordinary skill in the art will readily appreciate how to implement some or all of the disclosed fingerprint sensor-based force estimation techniques using other types of fingerprint sensors.

FIGS. 6A and 6B show images that correspond with signals provided by an ultrasonic fingerprint sensor for a light finger touch and a heavy finger touch, respectively. In FIGS. 6A and 6B, the dark areas are areas of relatively low-amplitude signals that correspond with reflections from platen/fingerprint ridge interfaces (also referred to herein as “R1”). Accordingly, the dark areas are examples of fingerprint ridge features, corresponding to areas in which fingerprint ridges are in contact with a platen of the ultrasonic fingerprint sensor. The light areas in FIGS. 6A and 6B are areas of relatively high-amplitude signals that correspond with reflections from a platen/air interface (also referred to herein as “R2”). The light areas that are interposed between the fingerprint ridge features in FIGS. 6A and 6B are examples of fingerprint valley features.

FIG. 6A is a graphic representation of signals provided by an ultrasonic fingerprint sensor when a finger is pressing on a platen with a relatively smaller force, whereas FIG. 6B is a graphic representation of signals provided by the ultrasonic fingerprint sensor when the same finger is pressing on the platen with a relatively larger force. It may be observed that the fingerprint ridge features in FIG. 6B are darker than the fingerprint ridge features in FIG. 6A. Moreover, it may be seen that the fingerprint ridge features in FIG. 6B are relatively thicker than the fingerprint ridge features in FIG. 6A, and that the fingerprint valley features in FIG. 6B are relatively thinner than the fingerprint valley features in FIG. 6A.

Accordingly, the fingerprint ridge features in FIG. 6B occupy a relatively larger percentage of the platen surface than the fingerprint ridge features in FIG. 6A. Because the fingerprint ridge features correspond to areas of relatively lower-amplitude signals, a relatively larger percentage of the reflections received by the ultrasonic fingerprint sensor will produce relatively lower-amplitude signals (corresponding with R1) when a finger is pressing on the platen with a relatively larger force. Accordingly, the median amplitude of signals provided by the ultrasonic fingerprint sensor will decrease when a finger is pressing on the platen with a relatively larger force. Another way of expressing this condition is that a sum (or average) of the reflected signals R1 and R2 from the platen-finger interface will decrease when a finger is pressing on the platen with a relatively larger force. In some implementations, a bounding box (e.g. a finger outline) may be determined to delineate the portion of a finger that is in contact with the platen and to define a fingerprint region that is within the bounding box (e.g., a region having fingerprint features) and a non-fingerprint region that is external to the bounding box (e.g., a region having no fingerprint features). Subsequently, the reflected signals from sensor pixels within the fingerprint region may be used to determine an indication of the amount of force applied by the finger by comparing the area of the fingerprint ridges to the area of the fingerprint valleys, determining a ratio of ridge area to the area of the fingerprint region, or alternatively, by adding all of the signals within the bounding box (or in some examples throughout the entire active area of the sensor) to determine a measure of the applied force.

In some disclosed examples, keyboard functionality may be controlled, at least in part, responsive to a detected digit rotation, a detected digit distortion or a detected digit swipe in one or more keyboard locations. Some examples of detecting digit rotations, digit distortions and digit swipes are disclosed in the following paragraphs.

FIGS. 7A and 7B show images that represent fingerprint image data corresponding to lateral (e.g., left- and right-directed) finger forces. In FIG. 7A, a rightward force is indicated by digit distortions that include a higher concentration of fingerprint ridge and valley features in the right side of the image, whereas in FIG. 7B a leftward force is indicated by digit distortions that include a higher concentration of fingerprint ridge and valley features in the left side of the image. This effect may or may not be caused by sliding the finger, which is also referred to herein as a “digit swipe.” In some instances, the type of digit distortions shown in FIGS. 7A and 7B may be a result of rocking the finger to the right or to the left, and/or by changes in the shape of the finger due to shear stress, particularly near the edges of the finger contact area.

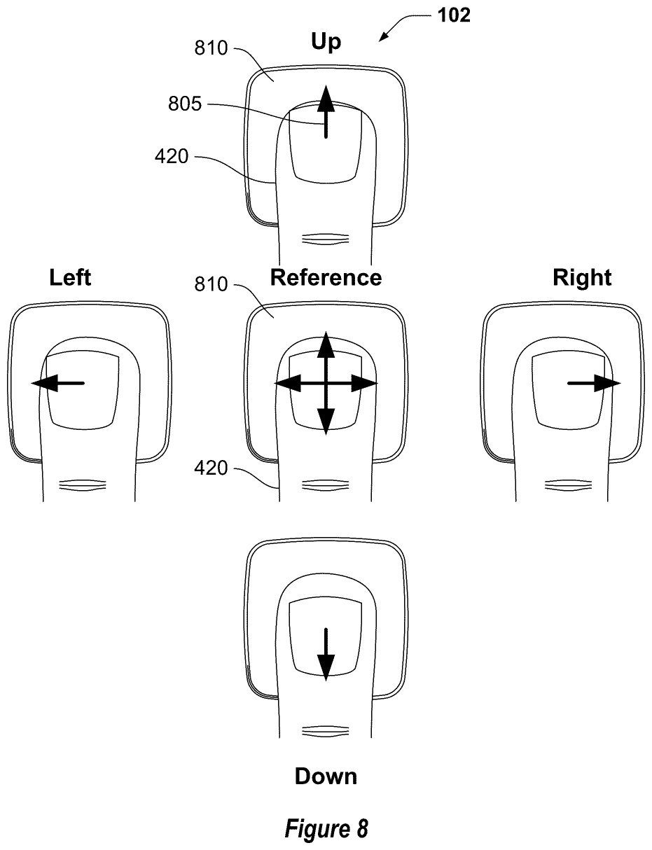

FIG. 8 shows images that represent exertions of a finger. In this example, the exertions of the finger 420 generate shear forces on a portion of a cover glass 810 of an apparatus 101 in an active area of a fingerprint sensor system 102 without the finger 420 sliding on the cover glass 810. The cover glass 810 may, for example, include glass, another durable transparent material, or a combination thereof. In this example, the fingerprint sensor system 102 includes an ultrasonic sensor system 102, whereas in other examples the fingerprint sensor system 102 may be, or may include, another type of fingerprint sensor system. A reference position of the finger 420 may correspond with the initial placement of the finger 420 on the cover glass 810. Directions corresponding to the direction of arrow 805 such as up, down, left, right and combinations thereof may correspond to digit distortions caused by exertions of the finger 420 against the cover glass 810, such as may occur when a finger is heavily pressed against a surface of the cover glass 810 and where the finger 420 fails to slide along the surface of the cover glass 810, yet deforms in response to the lateral physical exertions caused by muscles of the hand and fingers that in turn may be detected by the ultrasonic sensor system 102 and interpreted by the control system 106.

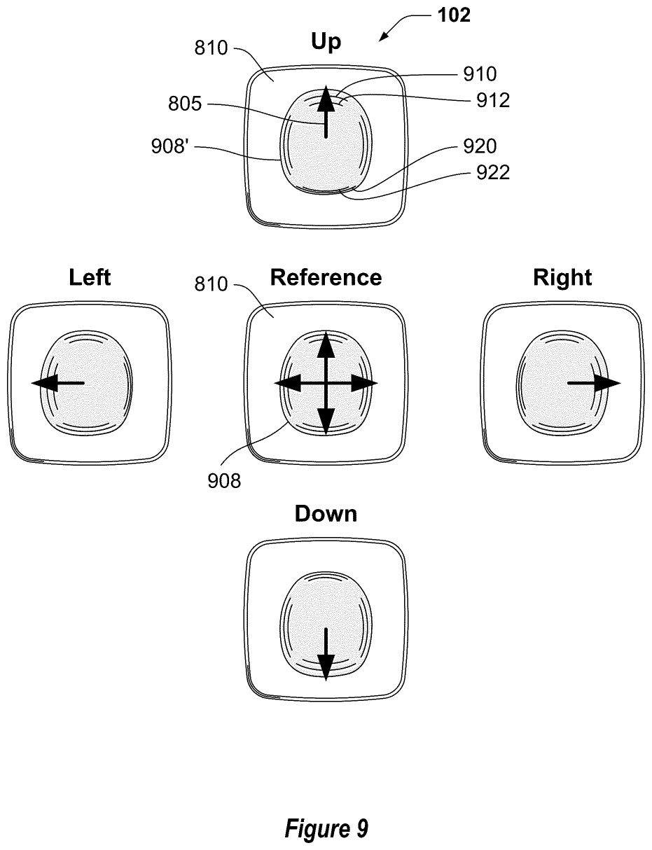

As normal finger forces generally cause the contact area of the fingerprint to change, distortions of the fingerprint ridges and valleys along with changes in contact area geometry generally occur with the generation of shear forces induced by exertions of the finger laterally against the platen surface. FIG. 9 shows images that represent digit distortions. In these examples, the digit distortions correspond to compressions and expansions of fingerprint ridge spacings that result from shear forces generated by exertions of a finger on a cover glass 810 of a fingerprint sensor. These changes in fingerprint ridge spacings are further examples of what may be referred to herein as finger distortions or digit distortions. In this example, the fingerprint sensor is a component of an ultrasonic sensor system 102. A reference position of the finger may correspond with the initial placement of the finger on the cover glass 810 that generates a fingerprint contact area 908 and associated contact area geometry. Directions corresponding to up, down, left, right and combinations thereof may correspond to movement of the fingerprint contact area 908′ in the direction of the arrow 805 or other directions due to exertions of the finger against the cover glass 810 where the finger fails to slide or partially slides along the surface of the cover glass 810, causing distortions of the spacings between adjacent fingerprint ridges and changes to the fingerprint contact area 908 and associated geometry. In the example illustrated, fingerprint ridges 910 and 912 near the leading edge of the fingerprint contact area 908′ are expanded with an increased fingerprint ridge spacing, whereas fingerprint ridges 920 and 922 near the trailing edge of the fingerprint contact area 908′ are compressed with a decreased fingerprint ridge spacing. Fingerprint ridges in other portions of the fingerprint contact area 908′ such as those near the center of the contact area may experience little if any distortion or displacement with lateral exertions of the finger while the finger continues to stay in contact with the cover glass 810 without sliding. The fingerprint valley regions may exhibit similar responses as the fingerprint ridges.

In some implementations, a keyboard-related input, such as a scrolling input, may be determined by computing a spatial frequency along a set of line segments that are perpendicular to the periphery of a fingerprint contact area. An elevated spatial frequency may correspond with a compressed set of fingerprint ridges, and a decreased spatial frequency may correspond with an expanded set of fingerprint ridges. For example, spatial frequencies may be determined along one, two, three, four or more line segments that are near the periphery of the fingerprint contact area and the determined spatial frequencies may be compared to previously-determined spatial frequencies from an earlier point in time to determine the direction and magnitude of a navigational input. Alternatively, spatial frequencies on one side of a finger contact area may be compared to one or more spatial frequencies on an opposite side of the finger contact area, and the difference in the spatial frequencies may indicate a navigational input. For example, spatial frequencies on the left side of a finger contact area may be increased while spatial frequencies on the right side of the finger contact area may be decreased, with the difference indicating a compressed ridge spacing on the left side and an expanded ridge spacing on the right side that corresponds with a direction of the navigational input to the right.

In some implementations, a measure of the shear force may be determined by measuring a change in the spacing between sweat pores or other fingerprint features, particularly those near the periphery of the fingerprint contact area, from which a magnitude and direction of a navigational input may be determined. Fingerprint features that are near the periphery of the fingerprint contact area may be referred to as being in a peripheral region of the fingerprint contact area. For example, an upwardly exerted finger may have stretched fingerprint features near the leading edge of the fingerprint contact area and compressed fingerprint features near the trailing edge of the fingerprint contact area, from which the direction and magnitude of the keyboard input (such as a scrolling input) may be determined.

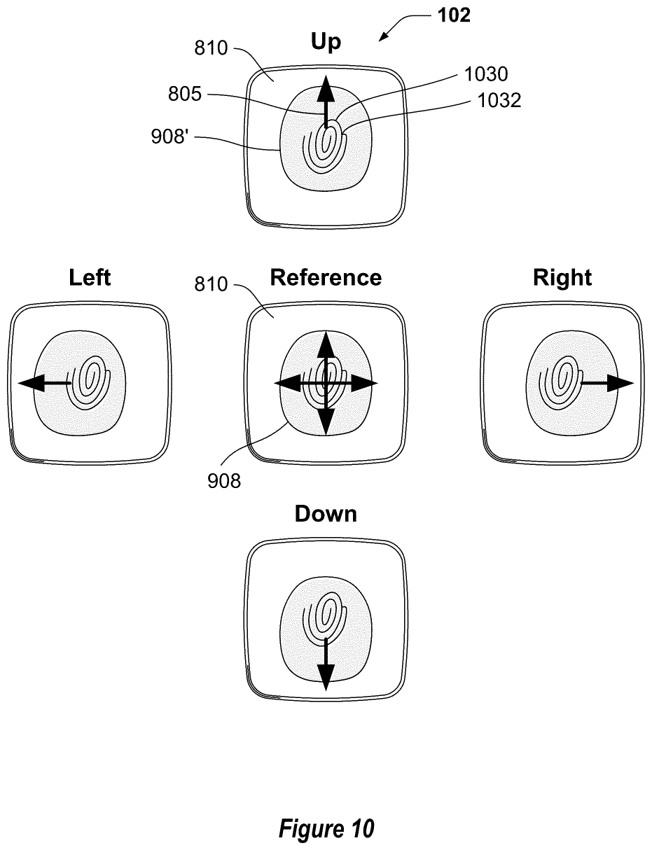

FIG. 10 shows images that represent movement of a fingerprint contact area. These examples represent movement of a fingerprint contact area 908 with respect to one or more fingerprint features 1030, 1032 resulting from shear forces generated by exertions of a finger on a cover glass 810. In this example, the fingerprint sensor is a component of an ultrasonic sensor system 102, whereas in other examples the fingerprint sensor may be, or may be a portion of, another type of fingerprint sensor system. Fingerprint features 1030, 1032 may correspond, for example, to a fingerprint whorl and a bifurcation point, respectively, in a fingerprint image. A reference position of the finger may correspond with the initial placement of the finger on the cover glass 810 that generates a fingerprint contact area 908 and associated contact area geometry. Scrolling directions corresponding to up, down, left, right and combinations thereof, or other types of keyboard-related inputs, may correspond to movement of the fingerprint contact area 908′ in the direction of the arrow 805 or other directions due to exertions of the finger against the cover glass 810 where the finger fails to slide along the surface of the cover glass 810, causing changes to the fingerprint contact area 908 and associated digit distortions including distances between the periphery of the fingerprint contact area 908 and the fingerprint features 1030, 1032. In some implementations, determination of the distances between the periphery of the fingerprint contact area 908 and fingerprint features 1030, 1032 in one or more directions may indicate a direction of a scrolling function to be performed.

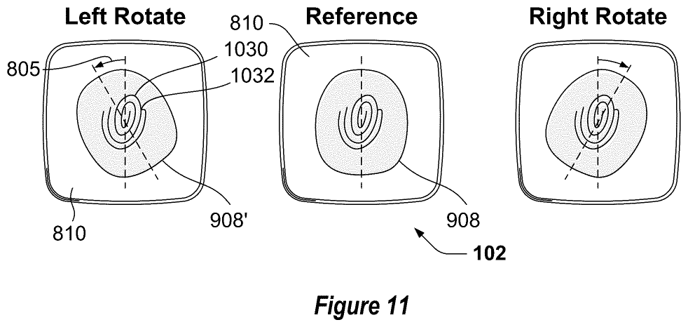

According to some examples, rotational movements of a finger may be detected using input from a fingerprint sensor system 102. FIG. 11 shows images that represent rotational movement of a digit. In this example, the images show rotational movement of a fingerprint contact area 908 with respect to one or more fingerprint features 1030, 1032 resulting from torsional forces generated by exertions of a finger on a cover glass 810 in an active area of a fingerprint sensor system 102. In this example, the fingerprint sensor system 102 is, or includes, an ultrasonic sensor system 102, whereas in other examples the fingerprint sensor system 102 may be, or may include, another type of fingerprint sensor. In some implementations, rotations clockwise or counterclockwise may be determined by acquiring fingerprint images from the fingerprint sensor, determining the size and shape of a periphery of a reference fingerprint contact area 908, then acquiring additional fingerprint images from the fingerprint sensor and determining the size and shape of the updated fingerprint contact area 908′ to allow determination of the direction of rotation and the angle of rotation. In the implementation illustrated, fingerprint features 1030, 1032 stay fixed (or substantially fixed) in position on the cover glass 810 while the finger is exerted in a twisting, angular motion in the direction of arrow 805 on the cover glass 810 without sliding or slipping of the fingerprint features 1030, 1032. Other fingerprint features such as ridges, valleys and minutiae near the periphery of the updated fingerprint contact area 908′ may be analyzed for distortions due to shear stress to determine the desired rotation direction and rotation magnitude. The direction of rotational motions of the finger, the magnitude (such as the angular extent) of rotational motions of the finger, or combinations thereof, may correspond with keyboard-related functionality (such as a scrolling direction) in some disclosed examples.

Implementation examples are described in the following numbered clauses:
1. An apparatus, including: a display system including one or more displays; a touch sensor system including a touch screen proximate a first side of a display of the display system; a force sensor system including an active force sensor area proximate a second side of the display; and a control system configured for communication with the display system, the touch sensor system and the force sensor system, the control system being further configured to: control the display system to present a graphical user interface (GUI), the GUI including a representation of a keyboard in at least a portion of the active force sensor area; receive, from the touch sensor system, an indication of a touch in a keyboard location of the GUI; receive, from the force sensor system, an indication of an applied force; determine whether the applied force is at or above a first force threshold; and control keyboard functionality according to whether the applied force is at or above the first force threshold.
2. The apparatus of clause 1, where the GUI includes a suggested word area in which suggested words are presented and where controlling the keyboard functionality involves selecting a suggested word responsive to determining that an applied force at a keyboard location outside of the suggested word area is at or above the first force threshold.
3. The apparatus of clause 2, where the suggested word is one of a plurality of suggested words and where controlling the keyboard functionality involves scrolling between suggested words of the plurality of suggested words responsive to a detected digit rotation or a detected digit swipe in one or more keyboard locations outside of the suggested word area.
4. The apparatus of any one of clauses 1-3, where the GUI includes a symbol presentation area in which symbols corresponding to selected key images of the keyboard are presented, each selected key image corresponding with a keyboard location.
5. The apparatus of clause 4, where the symbols include letters and where the control system is further configured to determine whether a letter presented in the symbol presentation area is the first letter of a word.
6. The apparatus of clause 5, where controlling the keyboard functionality involves changing the case of the letter responsive to determining that the letter is the first letter of the word and that the applied force is at or above the first force threshold.
7. The apparatus of clause 6, where the keyboard does not include a key image specifically for changing the case of a letter in the symbol presentation area.
8. The apparatus of clause 5, where controlling the keyboard functionality involves adding one or more spaces after the letter responsive to determining that the letter is not the first letter of a word and that the applied force is at or above the first force threshold.
9. The apparatus of any one of clauses 1-8, where controlling the keyboard functionality involves changing symbols corresponding to one or more key images of the keyboard.
10. The apparatus of clause 9, where changing the symbols corresponding to the one or more key images of the keyboard involves substituting one or more alphabetical key images for one or more non-alphabetical key images, or vice versa.
11. The apparatus of clause 9, where changing the symbols corresponding to the one or more key images of the keyboard involves substituting first symbols corresponding to a first language for second symbols corresponding to a second language.
12. The apparatus of any one of clauses 9-11, where the keyboard does not include a key image specifically for changing symbols corresponding to one or more key images of the keyboard.
13. The apparatus of any one of clauses 1-12, where the control system is further configured to: determine whether the applied force is at or above a second force threshold; and control keyboard functionality according to whether the applied force is at or above the second force threshold.
14. The apparatus of any one of clauses 1-13, where the control system is further configured to: determine whether each applied force of a plurality of applied forces is at or above the first force threshold; and control keyboard functionality according to whether each applied force of the plurality of applied forces is at or above the first force threshold.
15. The apparatus of clause 14, where the plurality of applied forces are detected at two or more keyboard locations of the GUI.
16. The apparatus of any one of clauses 1-15, where the indication of the applied force is received at the keyboard location.
17. A method of providing a graphical user interface (GUI), the method including: controlling a display system to present the GUI, the GUI including a representation of a keyboard in at least a portion of an active force sensor area of a force sensor system; receiving, from a touch sensor system, an indication of a touch in a keyboard location of the GUI; receiving, from the force sensor system, an indication of an applied force; determining whether the applied force is at or above a first force threshold; and controlling keyboard functionality corresponding with the GUI according to whether the applied force is at or above the first force threshold.
18. The method of clause 17, where the GUI includes a suggested word area in which suggested words are presented and where controlling the keyboard functionality involves selecting a suggested word responsive to determining that an applied force at a keyboard location outside of the suggested word area is at or above the first force threshold.
19. The method of clause 18, where the suggested word is one of a plurality of suggested words and where controlling the keyboard functionality involves scrolling between suggested words of the plurality of suggested words responsive to a detected digit rotation, a detected digit distortion or a detected digit swipe in one or more keyboard locations outside of the suggested word area.
20. The method of any one of clauses 17-19, where the GUI includes a symbol presentation area in which symbols corresponding to selected key images of the keyboard are presented, each selected key image corresponding with a keyboard location.
21. The method of clause 20, where the symbols include letters and where the method may involve determining whether a letter presented in the symbol presentation area is the first letter of a word.
22. The method of clause 21, where controlling the keyboard functionality involves changing the case of the letter responsive to determining that the letter is the first letter of the word and that the applied force is at or above the first force threshold.
23. The method of clause 22, where the keyboard does not include a key image specifically for changing the case of a letter in the symbol presentation area.
24. The method of clause 21, where controlling the keyboard functionality involves adding one or more spaces after the letter responsive to determining that the letter is not the first letter of a word and that the applied force is at or above the first force threshold.
25. The method of any one of clauses 17-24, where controlling the keyboard functionality involves changing symbols corresponding to one or more key images of the keyboard.
26. The method of clause 25, where changing the symbols corresponding to the one or more key images of the keyboard involves substituting one or more alphabetical key images for one or more non-alphabetical key images, or vice versa.
27. The method of clause 25, where changing the symbols corresponding to the one or more key images of the keyboard involves substituting first symbols corresponding to a first language for second symbols corresponding to a second language.
28. The method of any one of clauses 25-27, where the keyboard does not include a key image specifically for changing symbols corresponding to one or more key images of the keyboard.
29. The method of any one of clauses 17-28, further including: determining whether the applied force is at or above a second force threshold; and controlling keyboard functionality according to whether the applied force is at or above the second force threshold.
30. The method of any one of clauses 17-29, further including: determining whether each applied force of a plurality of applied forces is at or above the first force threshold; and controlling keyboard functionality according to whether each applied force of the plurality of applied forces is at or above the first force threshold.
31. The method of clause 30, where the plurality of applied forces are detected at two or more keyboard locations of the GUI.
32. The method of any one of clauses 17-31, where the indication of the applied force is received at the keyboard location.
33. An apparatus, including: a display system including one or more displays; a touch sensor system including a touch screen proximate a first side of a display of the display system; a force sensor system including an active force sensor area proximate a second side of the display; and control means for: controlling the display system to present a graphical user interface (GUI), the GUI including a representation of a keyboard in at least a portion of the active force sensor area; receiving, from the touch sensor system, an indication of a touch in a keyboard location of the GUI; receiving, from the force sensor system, an indication of an applied force; determining whether the applied force is at or above a first force threshold; and controlling keyboard functionality according to whether the applied force is at or above the first force threshold.
34. The apparatus of clause 33, where the GUI includes a suggested word area in which suggested words are presented and where controlling the keyboard functionality involves selecting a suggested word responsive to determining that an applied force at a keyboard location outside of the suggested word area is at or above the first force threshold.
35. The apparatus of clause 34, where the suggested word is one of a plurality of suggested words and where controlling the keyboard functionality involves scrolling between suggested words of the plurality of suggested words responsive to a detected digit rotation or a detected digit swipe in one or more keyboard locations outside of the suggested word area.
36. One or more non-transitory media having instructions for controlling one or more devices to perform a method stored therein, the method including: controlling a display system to present the GUI, the GUI including a representation of a keyboard in at least a portion of an active force sensor area; receiving, from a touch sensor system, an indication of a touch in a keyboard location of the GUI; receiving, from a force sensor system, an indication of an applied force; determining whether the applied force is at or above a first force threshold; and controlling keyboard functionality corresponding with the GUI according to whether the applied force is at or above the first force threshold.
37. The one or more non-transitory media of clause 36, where the GUI includes a suggested word area in which suggested words are presented and where controlling the keyboard functionality involves selecting a suggested word responsive to determining that an applied force at a keyboard location outside of the suggested word area is at or above the first force threshold.
38. The one or more non-transitory media of clause 37, where the suggested word is one of a plurality of suggested words and where controlling the keyboard functionality involves scrolling between suggested words of the plurality of suggested words responsive to a detected digit rotation or a detected digit swipe in one or more keyboard locations outside of the suggested word area.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus, comprising:
a display system including one or more displays;
a touch sensor system including a touch screen proximate a first side of a display of the display system;
a force sensor system including an active force sensor area proximate a second side of the display; and
a control system configured for communication with the display system, the touch sensor system and the force sensor system, the control system being further configured to:
control the display system to present a graphical user interface (GUI), the GUI including a representation of a keyboard in at least a portion of the active force sensor area;
receive, from the touch sensor system, an indication of a touch in a keyboard location of the GUI;
receive, from the force sensor system, an indication of an applied force;
determine whether the applied force is at or above a first force threshold; and
control keyboard functionality according to whether the applied force is at or above the first force threshold.

2. The apparatus of claim 1, wherein the GUI includes a suggested word area in which suggested words are presented and wherein controlling the keyboard functionality involves selecting a suggested word responsive to determining that an applied force at a keyboard location outside of the suggested word area is at or above the first force threshold.

3. The apparatus of claim 2, wherein the suggested word is one of a plurality of suggested words and wherein controlling the keyboard functionality involves scrolling between suggested words of the plurality of suggested words responsive to a detected digit rotation or a detected digit swipe in one or more keyboard locations outside of the suggested word area.

4. The apparatus of claim 1, wherein the GUI includes a symbol presentation area in which symbols corresponding to selected key images of the keyboard are presented, each selected key image corresponding with a keyboard location.

5. The apparatus of claim 4, wherein the symbols include letters and wherein the control system is further configured to determine whether a letter presented in the symbol presentation area is the first letter of a word.

6. The apparatus of claim 5, wherein controlling the keyboard functionality involves changing the case of the letter responsive to determining that the letter is the first letter of the word and that the applied force is at or above the first force threshold.

7. The apparatus of claim 6, wherein the keyboard does not include a key image specifically for changing the case of a letter in the symbol presentation area.

8. The apparatus of claim 5, wherein controlling the keyboard functionality involves adding one or more spaces after the letter responsive to determining that the letter is not the first letter of a word and that the applied force is at or above the first force threshold.

9. The apparatus of claim 1, wherein controlling the keyboard functionality involves changing symbols corresponding to one or more key images of the keyboard.

10. The apparatus of claim 9, wherein changing the symbols corresponding to the one or more key images of the keyboard involves substituting one or more alphabetical key images for one or more non-alphabetical key images, or vice versa.

11. The apparatus of claim 9, wherein changing the symbols corresponding to the one or more key images of the keyboard involves substituting first symbols corresponding to a first language for second symbols corresponding to a second language.

12. The apparatus of claim 9, wherein the keyboard does not include a key image specifically for changing symbols corresponding to one or more key images of the keyboard.

13. The apparatus of claim 1, wherein the control system is further configured to:
determine whether the applied force is at or above a second force threshold; and
control keyboard functionality according to whether the applied force is at or above the second force threshold.

14. The apparatus of claim 1, wherein the control system is further configured to:
determine whether each applied force of a plurality of applied forces is at or above the first force threshold; and
control keyboard functionality according to whether each applied force of the plurality of applied forces is at or above the first force threshold.

15. The apparatus of claim 14, wherein the plurality of applied forces are detected at two or more keyboard locations of the GUI.

16. The apparatus of claim 1, wherein the indication of the applied force is received at the keyboard location.

17. A method of providing a graphical user interface (GUI), the method comprising:
controlling a display system to present the GUI, the GUI including a representation of a keyboard in at least a portion of an active force sensor area of a force sensor system;
receiving, from a touch sensor system, an indication of a touch in a keyboard location of the GUI;
receiving, from the force sensor system, an indication of an applied force;
determining whether the applied force is at or above a first force threshold; and
controlling keyboard functionality corresponding with the GUI according to whether the applied force is at or above the first force threshold.

18. The method of claim 17, wherein the GUI includes a suggested word area in which suggested words are presented and wherein controlling the keyboard functionality involves selecting a suggested word responsive to determining that an applied force at a keyboard location outside of the suggested word area is at or above the first force threshold.

19. The method of claim 18, wherein the suggested word is one of a plurality of suggested words and wherein controlling the keyboard functionality involves scrolling between suggested words of the plurality of suggested words responsive to a detected digit rotation, a detected digit distortion or a detected digit swipe in one or more keyboard locations outside of the suggested word area.

20. The method of claim 17, wherein the GUI includes a symbol presentation area in which symbols corresponding to selected key images of the keyboard are presented, each selected key image corresponding with a keyboard location.

21. The method of claim 20, wherein the symbols include letters and wherein the method may involve determining whether a letter presented in the symbol presentation area is the first letter of a word.

22. The method of claim 21, wherein controlling the keyboard functionality involves changing the case of the letter responsive to determining that the letter is the first letter of the word and that the applied force is at or above the first force threshold.

23. The method of claim 22, wherein the keyboard does not include a key image specifically for changing the case of a letter in the symbol presentation area.

24. The method of claim 21, wherein controlling the keyboard functionality involves adding one or more spaces after the letter responsive to determining that the letter is not the first letter of a word and that the applied force is at or above the first force threshold.

25. The method of claim 17, wherein controlling the keyboard functionality involves changing symbols corresponding to one or more key images of the keyboard.

26. The method of claim 25, wherein changing the symbols corresponding to the one or more key images of the keyboard involves substituting one or more alphabetical key images for one or more non-alphabetical key images, or vice versa.

27. The method of claim 25, wherein changing the symbols corresponding to the one or more key images of the keyboard involves substituting first symbols corresponding to a first language for second symbols corresponding to a second language.

28. The method of claim 25, wherein the keyboard does not include a key image specifically for changing symbols corresponding to one or more key images of the keyboard.

29. The method of claim 17, further comprising:
determining whether the applied force is at or above a second force threshold; and
controlling keyboard functionality according to whether the applied force is at or above the second force threshold.

30. The method of claim 17, further comprising:
determining whether each applied force of a plurality of applied forces is at or above the first force threshold; and
controlling keyboard functionality according to whether each applied force of the plurality of applied forces is at or above the first force threshold.

31. The method of claim 30, wherein the plurality of applied forces are detected at two or more keyboard locations of the GUI.

32. The method of claim 17, wherein the indication of the applied force is received at the keyboard location.

33. An apparatus, comprising:
a display system including one or more displays;
a touch sensor system including a touch screen proximate a first side of a display of the display system;
a force sensor system including an active force sensor area proximate a second side of the display; and
control means for:
controlling the display system to present a graphical user interface (GUI), the GUI including a representation of a keyboard in at least a portion of the active force sensor area;
receiving, from the touch sensor system, an indication of a touch in a keyboard location of the GUI;
receiving, from the force sensor system, an indication of an applied force;
determining whether the applied force is at or above a first force threshold; and
controlling keyboard functionality according to whether the applied force is at or above the first force threshold.

34. The apparatus of claim 33, wherein the GUI includes a suggested word area in which suggested words are presented and wherein controlling the keyboard functionality involves selecting a suggested word responsive to determining that an applied force at a keyboard location outside of the suggested word area is at or above the first force threshold.

35. The apparatus of claim 34, wherein the suggested word is one of a plurality of suggested words and wherein controlling the keyboard functionality involves scrolling between suggested words of the plurality of suggested words responsive to a detected digit rotation or a detected digit swipe in one or more keyboard locations outside of the suggested word area.

36. One or more non-transitory media having instructions for controlling one or more devices to perform a method stored therein, the method comprising:
controlling a display system to present the GUI, the GUI including a representation of a keyboard in at least a portion of an active force sensor area;
receiving, from a touch sensor system, an indication of a touch in a keyboard location of the GUI;
receiving, from a force sensor system, an indication of an applied force;
determining whether the applied force is at or above a first force threshold; and
controlling keyboard functionality corresponding with the GUI according to whether the applied force is at or above the first force threshold.

37. The one or more non-transitory media of claim 36, wherein the GUI includes a suggested word area in which suggested words are presented and wherein controlling the keyboard functionality involves selecting a suggested word responsive to determining that an applied force at a keyboard location outside of the suggested word area is at or above the first force threshold.

38. The one or more non-transitory media of claim 37, wherein the suggested word is one of a plurality of suggested words and wherein controlling the keyboard functionality involves scrolling between suggested words of the plurality of suggested words responsive to a detected digit rotation or a detected digit swipe in one or more keyboard locations outside of the suggested word area.
